(19) United States
(12) Patent Application Publication
(10) Pub. No.: US 2010/0173594 A1
(43) Pub. Date: Jul. 8, 2010

(54) METHOD AND SYSTEM FOR RF COMMUNICATION FREQUENCY ARBITRATION

(76) Inventors: Alan Stettler, Murray, UT (US); Scott Smith, Murray, UT (US)

Correspondence Address: SNELL & WILMER LLP (OC), 600 ANTON BOULEVARD, SUITE 1400, COSTA MESA, CA, 92626, US

(21) Appl. No.: 12/652,588

(22) Filed: Jan. 5, 2010

Related U.S. Application Data
(60) Provisional application No. 61/142,812, filed on Jan. 6, 2009.

(51) Int. Cl. H04B 1/40

(52) U.S. Cl. 455/77

(57) ABSTRACT

The present invention relates to bandwidth management or Arbitration of RF spectrum in multiple dwelling units through over-the-air channels and/or over power line channels. In one embodiment, each communication system including a base unit and/or extension unit scanning the usable frequencies for their particular set of optimal channels. And then share their optimal set of channels with all other communication systems in the detectable vicinity. Ancillary communications channels are established between all communication systems allowing for the current frequency assignments or rotational assignments to be passed to all communication systems within the same local environment. All bad or unusable channels common to the local environment are tracked and logged in all communication systems.

### RELATED APPLICATIONS

This application claims the benefit of U.S. Provisional Patent Application Ser. No. 61/142,812, entitled “RF COMMUNICATION FREQUENCY ARBITRATION METHOD,” filed on Jan. 6, 2009, which is incorporated herein in its entirety.

### BACKGROUND

1. Field

The present invention relates to bandwidth management or Arbitration of RF spectrum in multiple dwelling units (“MDUs”) through over-the-air channels and/or over power line channels. More specifically, the present invention relates to bandwidth management or arbitration of RF spectrum in MDUs which may have its own voice and/or data RF communication system requiring use of the same band spectrum in the local vicinity.

2. Related Art

RF wireless communications ultimately boils down to utilizing a clear channel where enough bandwidth and signal to noise ratio exists for the desired information to be recovered on the receiving end for each dwelling or business which is currently using the same RF Communication system.

This problem can be illustrated, for example, when using a visible spectrum of light to represent the RF spectrum. If a person knowing Morse code was watching a first light source such as a single white signal light flashing in the distance at night, this person could easily decode the messages transmitted. However, if a second light source such as another white signal light flashing within sight of the person, the signal would remain at the same strength but the noise would rise. This decreases the signal to noise ratio. The closer in proximity the second light source gets to the first light source, the lower the signal to noise ratio.

When the second light source is directly in line with the first light source the receiving signal to noise ratio is 1 to 1, meaning both lights are flashing directly on top of one another making it completely impossible for the person to decode the proper message from the first light source. By adding multiple light sources within viewing sight of the person, the task becomes more difficult to do, thus increasing the noise level at a faster rate.

When the first light source moves closer to the person, the strength of the first light increases making the task of decoding the information in the presence of a noise light source such as the second light source easier. However, if the first light source moves into the distance away from the person the strength of the first light source decreases, which subsequently decreases the signal to noise ratio rapidly.

This problem exists for communication systems in locations where multiple communication systems exist. Frequency hopping spread spectrum systems sharing the same frequency bandwidth often operate independently of each other. Because each independent system is incapable of communication with other systems in the local vicinity, any particular system cannot easily predict the channel use, at any given moment, by the other systems sharing the same frequency bandwidth in the same vicinity. The inability of each independent system to communicate with each other results in transmission collisions appearing as noise to other systems sharing the same frequency bandwidth in the same vicinity.

Conventional communication systems deal with transmission collision by means of data collision detection. When a collision occurs, data is lost, requiring the data to be retransmitted. However, retransmission of data further degrades the communication channel by increasing the probability of transmission collisions. As more communication systems sharing the same frequency bandwidth are added, the rate of transmission collisions and data retransmission will increase dramatically, to the point that communication may become difficult or impossible for some or all of the communication systems. One example where such problems can occur are multiple dwelling units (“MDUs”), where communications frequencies have a higher occupancy. In MDUs, transmission collision rates rise dramatically which can cause significantly reduced throughput.

Thus, there is a need for a method and apparatus which can reduce transmission collisions while increasing the signal to noise ratio.

### SUMMARY

The present invention is a method and apparatus which reduces transmission collisions by improving utilization of locally available radio frequency spectrum. The present invention utilizes a communications channel which synchronizes and shares channel arbitration information with all like independent systems sharing the same RF spectrum in the local vicinity. By reducing or eliminating transmission collisions, the present invention allows faster and more error free communications.

Each communication system can include, for example, a base unit and/or extension unit for scanning the usable frequencies to determine their particular set of optimal transmission channels. Furthermore, each such communication system can, for example, share its optimal set of channels with all other communication systems in the detectable vicinity. Ancillary communications channels are established between all communication systems within the detectable vicinity (local environment) allowing for the then current frequency assignments or rotational assignments to be passed to all communication systems within the same local environment. All bad or unusable channels common to the local environment are tracked and logged in all communication systems.

In one embodiment, the present invention is a communication system including a transceiver transmitting and receiving according to a frequency hopping sequence, and a microcontroller connected to the transceiver. The microcontroller can be configured to analyze available channels to determine which channels are used by an adjacent communication system, and set the frequency hopping sequence to avoid using the channels used by the adjacent communication system.

In another embodiment, the present invention is a method for selecting channel usage by a first communication system with a second communication system adjacent the first communication system, the method including analyzing available channels to determine which channels are used by the second communication system, and setting a frequency hopping sequence for the first communication system to avoid using the channels used by the second communication system.

In yet another embodiment, the present invention is a method for selecting channel usage by a first communication system with a second communication system adjacent the first communication system, the method including communicating with the second communication system to determine channels used by the first communication system and the second communication system, and uniquely assigning channels to the first communication system and the second communication system.

Advantages and other novel features of this invention are set forth in the description that follows and will become apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there are shown and described embodiments of this invention, simply by way of illustration of the best modes known to the inventors to carry out this invention. As it will be realized, this invention is capable of other different embodiments, and in its details and specific circuits; it is capable of modification in various aspects without departing from the concept of this invention. Accordingly, the objects, drawings, and descriptions should be regarded as illustrative in nature and not as restrictive.

### BRIEF DESCRIPTION OF THE DRAWINGS

The features, objects, and advantages of the invention will become more apparent from the detailed description set forth below when taken in conjunction with the drawings, wherein:

FIG. 1 is a diagram of a communication system in a dwelling unit according to an embodiment of the present invention;

FIG. 2 is a diagram of multiple communication systems in a multiple dwelling unit according to an embodiment of the present invention;

FIG. 3 is a diagram of a base unit and an extension unit communicating using over the air RF frequency hopping spread spectrum according to an embodiment of the present invention;

FIG. 4 is a RF spectrum diagram depicting frequency hopping sequences according to an embodiment of the present invention;

FIG. 5 is a diagram depicting base units utilizing ancillary data communications to synchronize and arbitrate communication systems installed in MDUs according to an embodiment of the present invention;

FIG. 6 is a power table according to an embodiment of the present invention;

FIG. 7 is a process according to an embodiment of the present invention;

FIG. 8 is a process according to an embodiment of the present invention;

FIG. 9 is a diagram of a base unit and an extension unit communicating using a power line carrier current RF frequency hopping spread spectrum according to another embodiment of the present invention; and

FIG. 10 is a schematic diagram of a base unit and an extension unit using both over the power line current carrier RF frequency hopping spread spectrum and over the air RF frequency hopping spread spectrum according to another embodiment of the present invention.

### DETAILED DESCRIPTION

The following description is exemplary in nature and is not intended to limit the scope, applicability, or configuration of the invention in any way. Various changes to the described embodiment may be made in the function and arrangement of the elements described herein without departing from the scope of the invention.

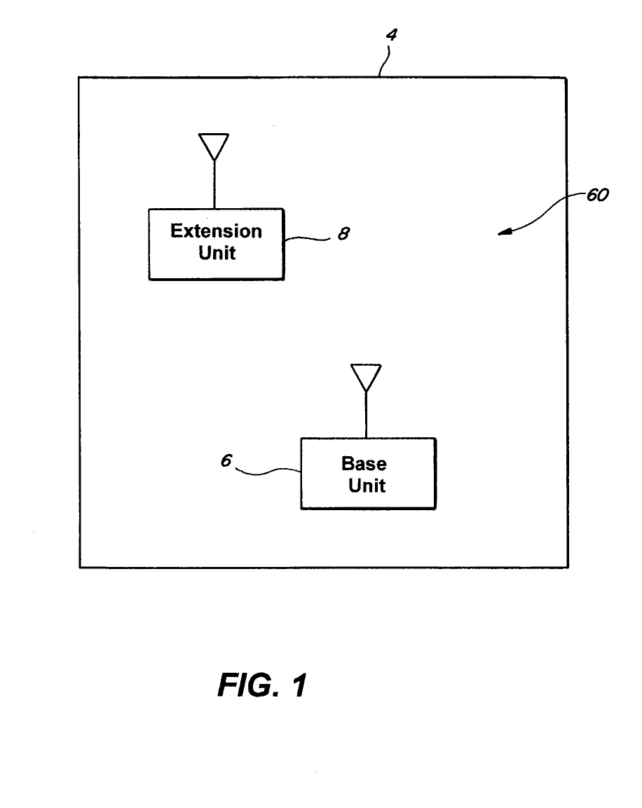

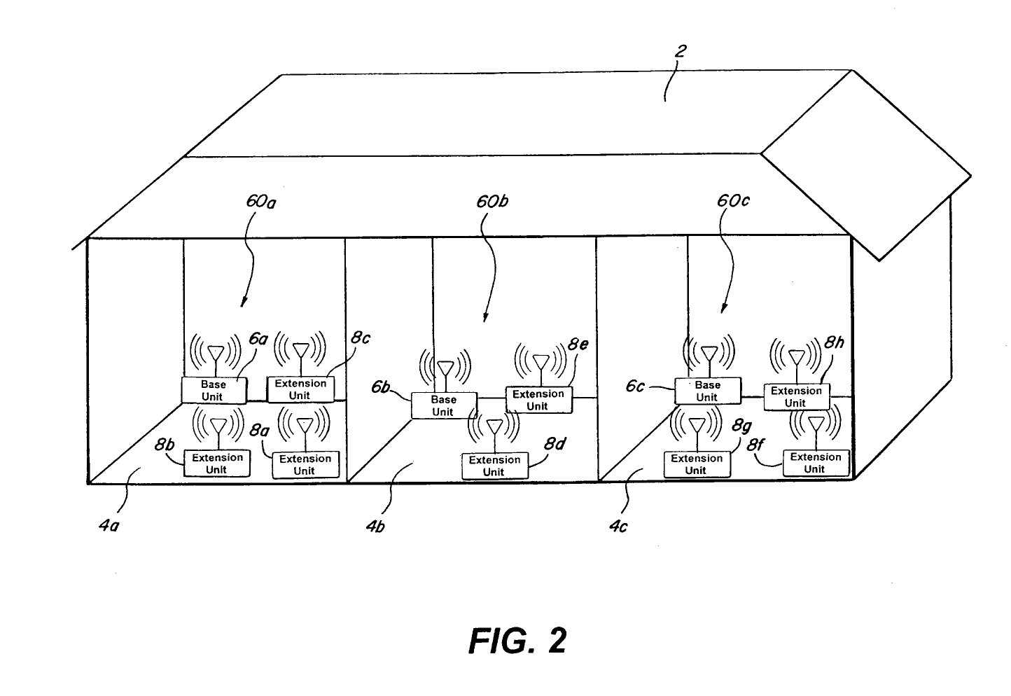

In FIG. 1, a dwelling unit 4 can include, for example, a base unit 6, and an extension unit 8. The base unit 6 and the extension unit 8 can for, for example, include a communication system 60. Although only a single extension unit 8 is shown in FIG. 1, more than one extension unit 8 may be included in the communication system 60. As seen in FIG. 2, a multiple dwelling unit (“MDU”) 2 includes multiple dwelling units such as dwelling unit 4a, dwelling unit 4b, and/or dwelling unit 4c. Dwelling units 4 can be, for example, adjoining small businesses and/or homes. Each dwelling unit 4a, dwelling unit 4b, and dwelling unit 4c includes a corresponding base unit 6a, base unit 6b, and base unit 6c, respectively. Furthermore, each dwelling unit can include one or more extension unit 8. For example, dwelling unit 4a can include extension units 8a, 8b, and 8c, dwelling unit 4b can include extension units 8d and 8e, and dwelling unit 4c can include extension units 8f, 8g, and 8h. Each base unit 6a, 6b, and 6c, can correspond to one or more extension units to form a communication system and each base unit and extension unit can receive and transmit RF signals amongst each other in the communication system. For example, base unit 6a can correspond to extension units 8a, 8b, and 8c to form a first communication system 60a, base unit 6b can correspond to extension units 8d and 8e to form a second communication system 60b, and base unit 6c can correspond to extension units 8f, 8g, and 8h to form the communication system 60c.

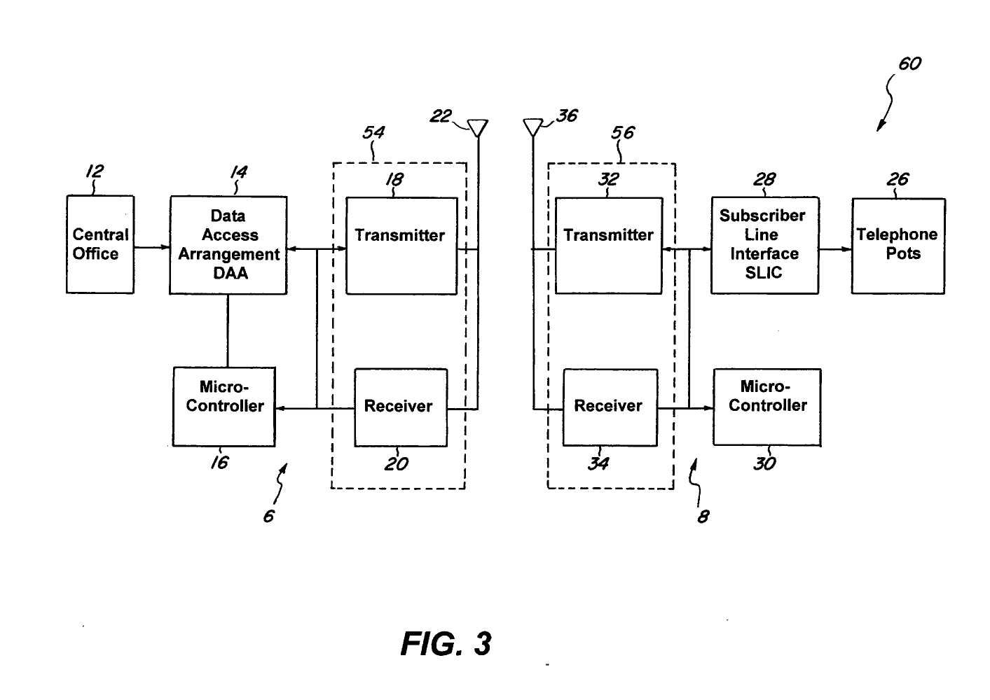

As seen in FIG. 3, the base unit 6 and the extension unit 8 can each include a receiver and a transmitter. The base unit 6 and the extension unit 8 can alternate being a receiver and a transmitter. Thus, during a first time period, base unit 6 can transmit data to the extension unit 8 and the base unit 6 can be the transmitter while extension unit 8 is the receiver. In a second time period, the extension unit 8 can transmit data to the base unit 6, and the extension unit 8 can be the transmitter while the base unit 6 is the receiver.

The base unit 6 includes a data access arrangement (“DAA”) 14, a microcontroller 16, transmitter 18, a receiver 20, and an antenna 22. The DAA 14 receives a signal 12 from a central office, a microcontroller 16, a transmitter 18, and a receiver 20. The central office 12 can be, for example, a telephone central office.

The microcontroller 16 is connected to the DAA 14, the transmitter 18, and/or the receiver 20. The microcontroller 16 can be, for example, a CPU or local intelligence units. Optionally, the microcontroller 16 can also include, for example, a memory unit connected to the CPU and/or local intelligence units. In one embodiment, the microcontroller 16 could possess sufficient decision making power to govern the sharing and use of the available bandwidth. Furthermore, the microcontroller 16 can also store and use a set of rules governing the sharing and use of the available bandwidth. The microcontroller 16 can, for example, share an available bandwidth with all other independent communication systems such as those including a base unit 6 and/or one or more extension units 8 located in the near vicinity. The antenna 22 is connected to the transmitter 18 and the receiver 20.

The transmitter 18 is connected to the DAA 14, the microcontroller 16, and/or the antenna 22. The transmitter 18 can support modulation of digital data in one or more digital modulation formats and allow frequency hopping on multiple channels inside the allocated frequency bandwidth. In one embodiment, the transmitter 18 can support frequency hopping on multiple channels inside the allocated frequency bandwidth. Using multiple channels can, for example, reduce communication congestion, improve SNR, and/or reduce a likelihood of errors in communications. In one embodiment, the transmitter 18 can support modulation of digital data in at least as many channels as required by a regulatory authority. The regulatory authority can be, for example, a rules setting organization, a governmental agency, or any other type of group which sets standards. The digital modulation types can be, for example, frequency modulation (“FM”), frequency-shift keying (“FSK”), phase-shift keying (“PSK”), quadrature amplitude modulation (“QAM”), or any other type of appropriate modulation.

The receiver 20 is connected to the DAA 14, the microcontroller 16, and/or the antenna 22. The receiver 20 can support demodulation of digital data in one or more of the digital modulation types, such as those described above. Furthermore, the receiver 20 can allow frequency hopping on multiple channels inside the allocated frequency bandwidth. In one embodiment, the receiver 20 can support frequency hopping on multiple channels inside the allocated frequency bandwidth. In one embodiment, the receiver 20 can support modulation of digital data in at least as many channels as required by the regulatory authority. In one embodiment, the transmitter 18 and the receiver 20 can form, for example, a transceiver 54. The transceiver 54 can operate, for example, according to a frequency hopping sequence, which will be described below.

The extension unit 8 includes a subscriber line interface (“SLIC”) 28, a microcontroller 30, a transmitter 32, a receiver 34, and an antenna 36. The SLIC 28 is connected to a plain old telephone system (“POTS”) compatible device 26, a microcontroller 30, a transmitter 32, and/or a receiver 34.

The microcontroller 30 is connected to the SLIC 28, the transmitter 32, and/or the receiver 34. The microcontroller 30 can be, for example, a CPU or local intelligence units. Optionally, the microcontroller 30 can also include, for example, a memory unit connected to the CPU and/or local intelligence units. In one embodiment, the microcontroller 30 could possess sufficient decision making power to govern the sharing and use of the available bandwidth. Furthermore, the microcontroller 30 can also store and use a set of rules governing the sharing and use of the available bandwidth. The microcontroller 30 can, for example, share an available bandwidth with all other independent communication systems such as those including a base unit 6 and/or one or more extension units 8 located in the near vicinity. In one embodiment, the near vicinity could be, for example, a distance where there is a strong likelihood of interference from the pairs of base unit 6 and/or extension unit 8. Antenna 36 is connected to transmitter 32 and receiver 34.

The transmitter 32 is connected to the SLIC 28, the microcontroller 30, and/or the antenna 36. The transmitter 32 can support modulation of digital data into the air in one or more modulation formats and allow frequency hopping on multiple channels inside the allocated frequency bandwidth. In one embodiment, the transmitter 32 can support frequency hopping on multiple channels inside the allocated frequency bandwidth. In one embodiment, the transmitter 32 can support modulation of digital data in at least as many channels as required by the regulatory authority. The digital modulation types can be, for example, FM, FSK, PSK, QAM, or any other type of appropriate modulation.

The receiver 34 is connected to the SLIC 28, the microcontroller 30, and/or the antenna 36. The receiver 34 can support demodulation of digital data from one or more of the digital modulation types, such as those described above. Furthermore, the receiver 34 can allow frequency hopping on multiple channels inside the allocated frequency bandwidth. In one embodiment, the receiver 34 supports frequency hopping on multiple channels inside the allocated frequency bandwidth. In one embodiment, the receiver 34 can support modulation of digital data in at least as many channels as required by the regulatory authority. In one embodiment, the transmitter 32 and the receiver 34 can form, for example, a transceiver 56. The transceiver 56 can operate, for example, according to a frequency hopping sequence.

Each base unit 6 can communicate with one or more extension units 8 passing real time data and information in full duplex between the currently selected extension unit 8 and its corresponding base unit 6. In one embodiment the DAA 14 in base unit 6 and the SLIC 28 in extension unit 8 may be replaced with the appropriate interface to move real time data in full duplex for any of the following but not limited to VOW, cellular phone, audio, or any other telephony apparatus. In operation a communication system including base unit 6 and extension unit 8 extends a particular type of telephony interface using over-the-air channels through an RF spread Spectrum radio system using any one of multiple digital modulation types such as FM, FSK, PSK, QAM, or others.

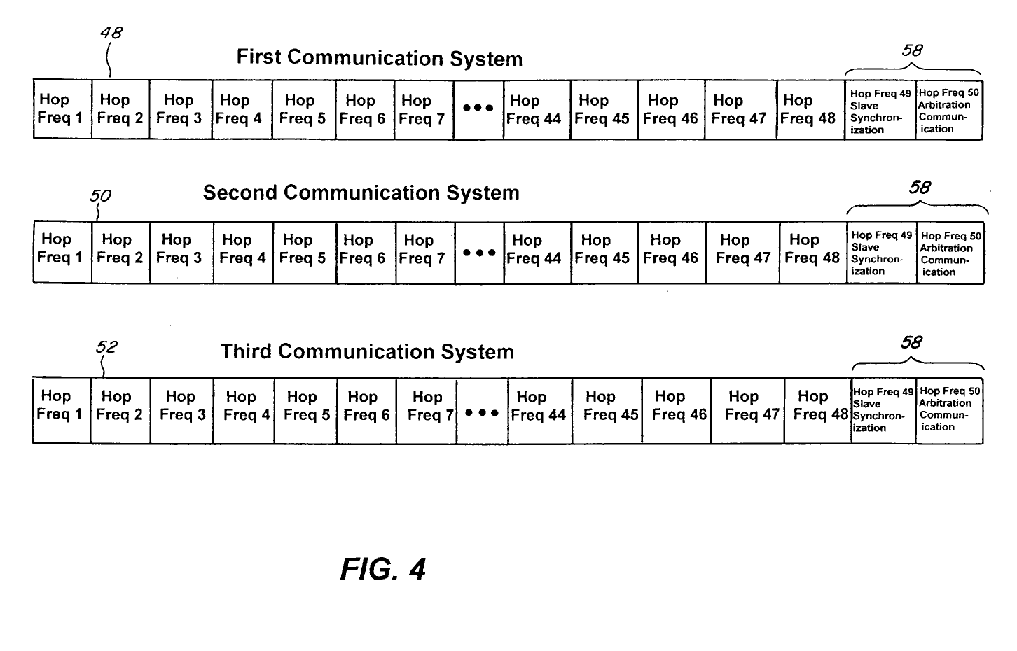

In FIG. 2, the base unit 6a and the extension units 8a, 8b, and 8c can communicate with each other using antenna 22 (FIG. 3) and antenna 36 (FIG. 3) through RF waves and over-the-air channels using frequency hopping spread spectrum as seen in FIG. 4. The base unit 6b and the extension units 8d and 8e can communicate with each other using antenna 22 and antenna 36 through RF waves and over-the-air channels using frequency hopping spread spectrum in FIG. 4. In addition, the base unit 6c and the extension units 8f, 8g, and 8h can communicate with each other using antenna 22 and antenna 36 through RF waves and over-the-air channels using frequency hopping spread spectrum shown in FIG. 4. In FIG. 4, the first communication system 60a (FIG. 2) in dwelling unit 4a can utilize a frequency hopping sequence 48, the second communication system 60b (FIG. 2) in dwelling unit 4b can utilize a frequency hopping sequence 50, and the third communication system 60c (FIG. 2) in dwelling unit 4c can utilize a frequency hopping sequence 52.

The frequency hopping sequences, for example, can be partial sequence frequency hopping, random sequence frequency hopping, consecutive sequence frequency hopping, or any other type of appropriate frequency hopping sequences. In one embodiment, 25 channels can be used in the 900 MHz industrial, scientific, and medical (“ISM”) band and 75 channels can be used in the 2.4 GHz band. The ISM band is defined by the International Telecommunications Union Radiocommunication Sector (“ITU-R”). In another embodiment, dwell time on each frequency or channel in any situation is no longer than 0.04 seconds.

The use of frequency hopping spread spectrum can optimize the communication channel signal to noise ratio in each pair of base unit 6 and extension unit 8 since frequency hopping spread spectrum can spread the transmitted power out over a larger set of frequencies. By doing this the instantaneous power levels may be raised to the maximum allowable power levels set by the Federal Communications Commission. This also enables each communication systems 60a, 60b, and 60c in MDU 2 to become frequency agile having the ability to send and receive signals on any given frequency pair in a given band.

Referring back to FIG. 2, the RF signals can propagate through walls of MDU 2, which can ordinarily cause severe interference between the base units 6a, 6b, and 6c, and the extension units 8a, 8b, 8c, 8d, 8e, 8f, 8g, and 8h. That is, the RF signals from each communication system can interfere with the RF signals for the other communication systems.

In operation, the present invention reduces interference problem in MDU 2 through power control and/or frequency agility. During power control, the output power of all the transmissions in the base units 6 and extension units 8 in MDU 2 can be reduced. During frequency agility, the frequency agility built into the frequency hopping transmission method is used. One or both of these methods can be utilized alone or in combination to overcome the interference problem present in MDU 2.

Reducing transmission power in the base units 6 and extension units 8 by itself may not be enough to significantly reduce the interference problem. The transmitted power required for satisfactory signal strength is greatly affected by the amount of solid substances which the signal must pass through in order to communicate with the appropriate receiver. Therefore due to location and obstructions in the line of site between base unit 6 and extension unit 8, higher power levels may be required from some transmissions. To more effectively reduce interference, in one embodiment of the present invention, power control is combined with frequency agility, thus allowing many communication systems to occupy the same frequency band within a given space. The present invention utilizes a clear channel and transmitter power control to allow a large number of communication systems to be supported in MDU 2 at any given time and is not limited to just the specific embodiments described below.

In one embodiment, microcontroller 16 and/or microcontroller 30 detects which frequencies are occupied at any given time and predicts which channel and at what time in the sequence each transmitter is going to transmit next. For example, the microcontroller 16 and/or the microcontroller 30 can determine an appropriate channel to transmit based on the analysis of which channels will be utilized at certain times by other communication systems and choosing channels which will not be utilized at certain times by the other communication systems. This analysis can be done, for example, through weighting or examination of the temporal usage of each channel and/or the clarity of each channel. This can, for example, eliminate a frequency conflict until all possible channels are occupied. As seen in FIG. 4, the first communication system, the second communication system, and the third communication system are utilizing the same frequency hopping sequence. The first communication system transmits data at channel Hop Freq 5 as the fifth channel in the sequence and receives data at channel Hop Freq 48 as the 48th channel in the sequence, the second communication system transmits data at channel Hop Freq 3 as the third channel in the sequence and receives data at channel Hop Freq 46 as the 46th channel in the sequence, and the third communication system transmits data at channel Hop Freq 1 as the first channel in the sequence and receives data at channel Hop Freq 44 in the 44th channel in the sequence.

Thus, each of the communication systems through their respective microcontrollers can detect when the other communication systems are transmitting and receiving data and what channels are utilized at what time. The communication systems can therefore appropriately adjust when each of the communication systems should transmit and receive data and what channels to use at what time in the frequency hopping sequence to reduce interference. Advantageously, with the present invention, even if all of the communication systems were using the same frequency hopping sequence of selecting the same channels for possible use for transmission or reception of data at the same time, collisions and interference can be reduced since the communication systems will appropriately determine which channels to utilize to transmit and receive data and/or when such data should be transmitted and received in the selected channel. Thus, if there is a fourth communication system, it can determine that channel Hop Freq 1, channel Hop Freq 3, channel Hop Freq 5, channel Hop Freq 44, channel Hop Freq 46, and channel Hop Freq 48, should be avoided when determining which Hop Freq to use to transmit and receive data since the fourth communication system can detect that those channels are being used by the first communication system 60a, the second communication system 60b, and/or the third communication system 60c. In one embodiment, the fourth communication system can also determine that the channel Hop Freq 1, channel Hop Freq 3, channel Hop Freq 5, channel Hop Freq 44, channel Hop Freq 46, and channel Hop Freq 48, should be avoided at certain times to avoid using those channels at the same time as the other communication systems.

In another embodiment, each communication system could utilize the same frequency hopping sequence, but offset the time period. Thus, for example, the first communication system could have a frequency hopping sequence of channel Hop Freq 1 as the first channel, channel Hop Freq 2 as the second channel, channel Hop Freq 3 as the third channel, etc. The second communication system could have a frequency hopping sequence of channel Hop Freq 50 as the first channel, channel Hop Freq 1 as the second channel, channel Hop Freq 2 as the third channel, etc. The third communication system could have a frequency hopping sequence of channel Hop Freq. 49 as the first channel, channel Hop Freq. 50 as the second channel, channel Hop Freq. 1 as the third channel, etc. Thus, although each communication system is utilizing the same sequence, the sequences are temporally offset for each communication system. This temporal offset can reduce collisions since during each time period, only one communication system will access a channel at a time.

In yet another embodiment, partial sequence is utilized where each independent communication system shares its bandwidth requirements with all other operating independent communication systems and allocates in the system its bandwidth requirements. Therefore it is assigned its own set of rotational or random channels unique to that communication system. For example, if there are 300 communication channels each communication system may be allowed to use 50 channels unique to only that communication system. This would allow for up to six communication system to operate simultaneous with no frequency conflict at all. Dwell time, channel bandwidth, and number of channels all could possibly be modified to optimize throughput for each particular communication system.

In one embodiment, one of the base units 6 in the communication system 60a can be a master, such as a master base unit, and the other base units 6b and 6c in the other communication systems 60b and 60c can be slaves, such as slave base units. The master can then perform the assignment of the channels to its own communication system and to the other communication systems. In one embodiment, when activated, a base unit searches for other base units. If it determines that there are no other base units, it assigns itself the master. When there is another base unit that is assigned the master, and other base units are slaves to that master, the base unit can assign itself the slave. When there is another base unit that is the master, and there are no slaves, indicating that there are only two base units within a vicinity of each other, the base units can arbitrarily assign one of the two base units as the master and the other one as the slave.

This allows all independent communication systems of the same type and in the same vicinity, to communicate via the RF radio links and agree upon the bandwidth allocation and frequency hopping algorithms to be used to avoid interference associated with each communication system thereby eliminating interference and maximizing system throughput for all communication systems in MDU 2. Also to further reduce the inference that occurs due to multiple transmitters running at the same time, the communications channel signal integrity is sampled and transmitter power will be reduced to the minimum allowable for that particular link to meet a predetermined minimum SNR level. The predetermined minimum SNR level can be set, for example, by Federal Communications Commission (“FCC”) guidelines. The predetermined minimum SNR level can also be set, for example, such that voice data can be adequately transmitted.

Advantageously, by using a different channel, it is easier for each base unit 6 and/or extension unit 8 within each communication system 60 to communicate with each other. For example, in the situation with the person knowing Morse code, each communication system using different channels is like each person being assigned different light colors. Once the person is assigned a unique color, it is easier for the receiving individual to discern which source is the original light source. For example, when the person knowing Morse code is assigned the blue spectrum and the color assignments are agreed upon by all persons in the area, each person focuses on its given color or light spectrum such as blue. Even though the light sources may be right on top of one another, the person can ignore all other light colors like green and red in the background. This separation of messages can be enhanced by placing color or spectrum filters in front of the receiving individuals eyes. Making each person within the vicinity have a greater signal to noise ratio. This allows for many simultaneous messages to get through.

This is similar to what occurs when multiple RF receivers and transmitters of the same frequency spectrum coexist in MDU 2. By making each communication system (source and destination) frequency agile, within a given frequency range, the problem of collisions can be reduced.

Synchronization data can include, for example master synchronizations, slave synchronizations, and/or arbitration communications. As seen in FIG. 4, synchronization data is transmitted in the last two frequency hops. The last two frequency hops used to transmit the synchronization data can be, for example, an ancillary communications link. These synchronization data can be used to synchronize and allocate the bandwidth. For example, channel Hop Freq 49 can be used for master synchronization and/or slave synchronization while channel Hop Freq 50 can be used for arbitration communications. Arbitration communications can be used to formulate arbitration tables which allow all communication systems in the vicinity to track the sequence of all other communication systems operating in the local vicinity. Although the synchronization data is transmitted in the last two frequency hops, synchronization data could also be placed at any location in the hop sequence. Furthermore, bad or unusable channels common to the local environment can be tracked and logged for each communication system in the arbitration table or an error table. The communication systems can, for example, use the arbitration table and/or the error table to formulate the frequency hopping sequence.

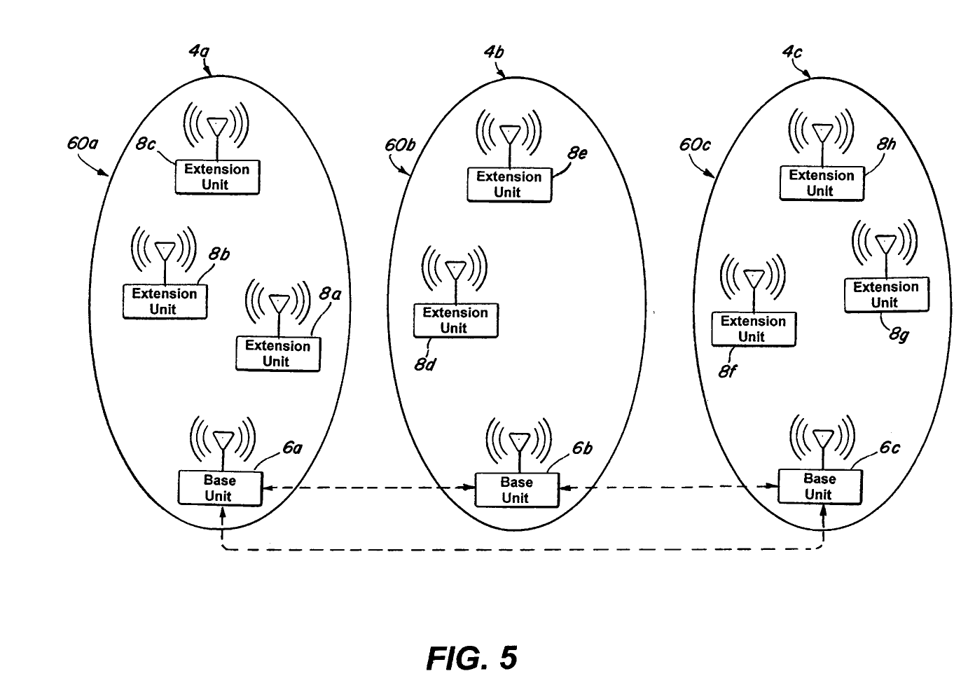

Thus, as seen in FIG. 5 the first communication system 60a in dwelling unit 4a, the second communication system 60b in dwelling unit 4b, and the third communication system 60c in dwelling unit 4c can synchronize and arbitrate with each other using base unit 6a, base unit 6b, and base unit 6c. This allows the three independent communication systems to share the bandwidth which has been negotiated through the ancillary communications link established between each of the base units. Each independent communication system can, for example, advertise their specific frequency needs allowing each independent communication systems to avoid frequencies used by other communication systems while minimizing bandwidth inefficiencies of all communication systems involved in the vicinity. This ancillary information is passed through the ancillary communications link in the allotted time. In FIG. 5, each dwelling unit 4 only has a single base unit 6 and two or three extension units 8, however, any number of base units 6 and extension units 8 may be used in each dwelling unit 4. Furthermore, the number of base units 6 and extension units 8 can vary from dwelling unit to dwelling unit.

Although the present invention allows arbitration, in one embodiment, each of the base units 6 can include an access security code or other security device to prevent other information from being transmitted. For example, the base unit 6a would be able to arbitrate with the base unit 6b and the base unit 6c, but the base unit 6a would be unable to impermissibly receive communication data between the base unit 6b and the extension unit 8d or communication data between the base unit 6c and the extension unit 8f.

In still yet another embodiment, a random frequency hopping sequence method is utilized where each communication system randomly assigns all or a portion of the frequency spectrum to each communication system. Thus, each communication system would utilize a random frequency hopping sequence. Until a geographic location of MDU 2 is completely flooded with transmitters, a particular channel will not have a conflict often enough to shut down any of the channels. This method allows for occasional frequency conflicts and relies on error detection and retransmission of bad data.

In another embodiment, each communication system through microcontroller 16 and/or microcontroller 30 in each base unit 6 and/or extension unit 8 evaluates and then optimizes the transmit power for each individual channel. Thus, interference created by one communication system and sent towards another communication system can be minimized. This transmit power level per channel is assessed on a channel per channel basis and each base unit 6 and/or extension unit 8 involved tests and stores the minimum transmit power values yielding adequate SNR levels for communicating with each other, for example, in a power table. This transmitter power adjustment works for both over the air channels and power line channels. In both cases the transmission medium in question offers different attenuation values for each individual transmission channel and its path. This adaptation method flattens out the response curve so all the signals received in the local vicinity are near the same level thus enhancing receiver SNR for each communication system. This makes use of the inherent attenuation built into the environment to increase SNR between different communication systems. Advantageously, a reduced power per modulation channel is achieved.

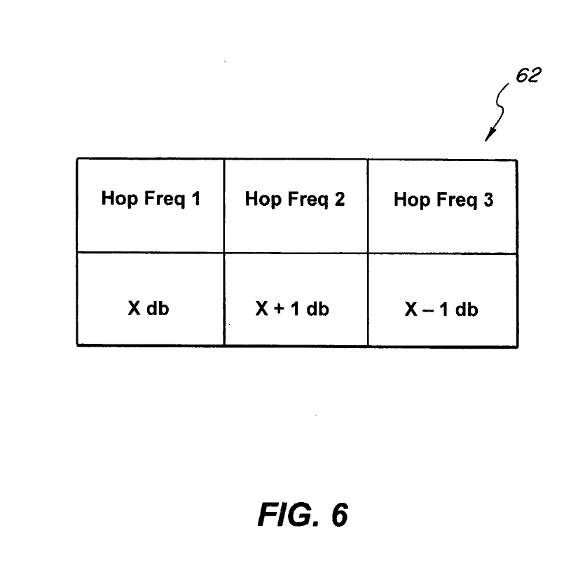

For example, FIG. 6 depicts a power table 62 for the first communication system. In the channel Hop Freq 1, the first communication system determines that a baseline transmit power X db should be used. However, in the channel Hop Freq 2, the first communication system determines that the transmit power should be increased over the baseline transmit power and thus X+1 db should be used. In the channel Hop Freq 3, the first communication system determines that the transmit power should be decreased over the baseline transmit power and thus X−1 db should be used. The baseline transmit power can be determined, for example, through a historical collection of transmit power, through a predetermined regulation such as an FCC regulation, a default factory setting, or any other acceptable method to determine a transmit power which can be appropriately varied.

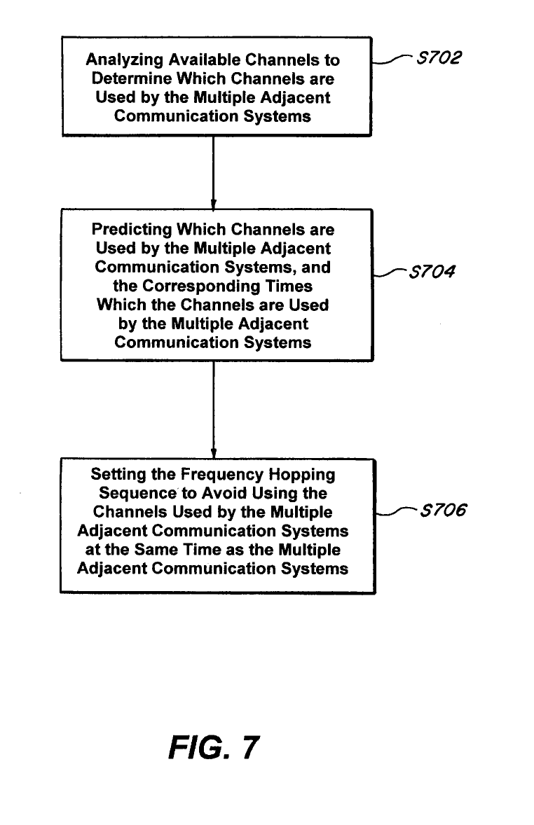

In one embodiment, the present invention is a process according to FIG. 7. In Step S702, available channels are analyzed to determine which channels are used by multiple adjacent communication systems. For example, the microcontroller 16 in base unit 6a can analyze available channels to determine which channels are used by multiple adjacent communication systems, such as the base unit 6b and/or the base unit 6c. In Step S704, a prediction is made regarding which channels are used by the multiple adjacent communication systems and the corresponding times which the channels are used by the multiple adjacent communication systems. For example, the microcontroller 16 in the base unit 6a can predict which channels are used at what time by the base unit 6b and/or the base unit 6c. In Step S706, a frequency hopping sequence is set to avoid using the channels used by the multiple adjacent communication systems at the same time as the multiple adjacent communication systems. For example, the microcontroller 16 in the base unit 6a can set a frequency hopping sequence for the base unit 6a to avoid using the channels used by the base unit 6b and/or the base unit 6c.

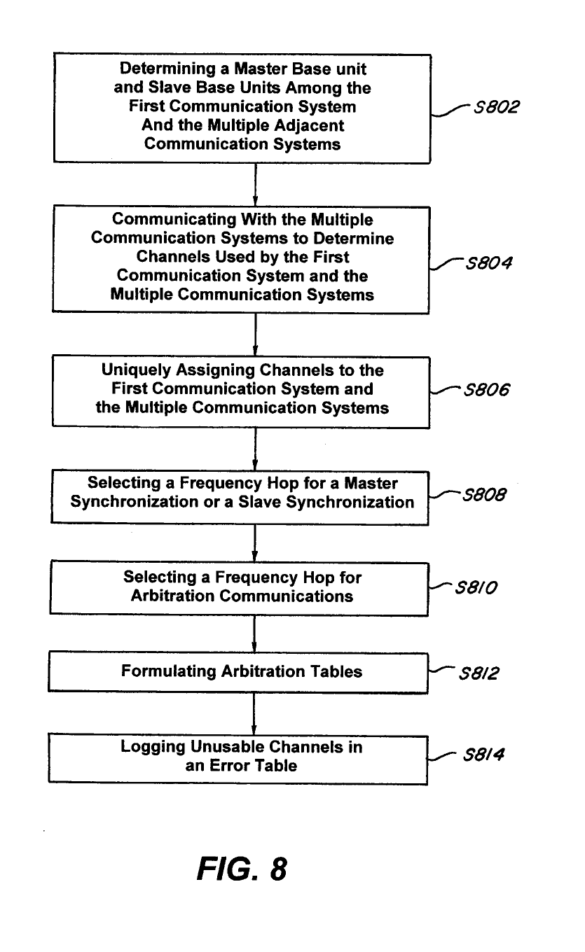

In another embodiment, the present invention is a process according to FIG. 8. In Step S802, a master base unit and slave base units are determined among a first communication system and multiple adjacent communication systems. For example, the base unit 6a, the base unit 6b, and/or the base unit 6c can determine which base unit is a master base unit and which base units are slave base units. In Step S804, a first communication system communicates with the multiple communication systems to determine channels used by the first communication system and the multiple communication systems. For example, the base unit 6a can communicate with the base unit 6b and/or the base unit 6c to determine which channels are used by the base unit 6a, the base unit 6b, and/or the base unit 6c.

In Step S806, channels are uniquely assigned to the first communication system and the multiple communication systems. For example, a microcontroller in the master base unit can assign channels to the base unit 6a, the base unit 6b, and/or the base unit 6c. If the base unit 6a is the master base unit, then the microcontroller 16 in the base unit 6a can assign channels to the base unit 6a, the base unit 6b, and/or the base unit 6c. In Step S808, a frequency hop for a master synchronization or a slave synchronization is selected. For example, the microcontrollers 16 in the base unit 6a, the base unit 6b, and/or the base unit 6c can select a frequency hop for a master synchronization or a slave synchronization. In Step S810, a frequency hop for arbitration communications is selected. For example, the microcontrollers 16 in the base unit 6a, the base unit 6b, and/or the base unit 6c can select a frequency hop for arbitration synchronization. In Step S812, arbitration tables are formulated. For example, the microcontrollers 16 in the base unit 6a, the base unit 6b, and/or the base unit 6c can formulate arbitration tables. In Step S814, unusable channels are logged in an error table. For example, the microcontrollers 16 in the base unit 6a, the base unit 6b, and/or the base unit 6c can log unusable channels in an error table.

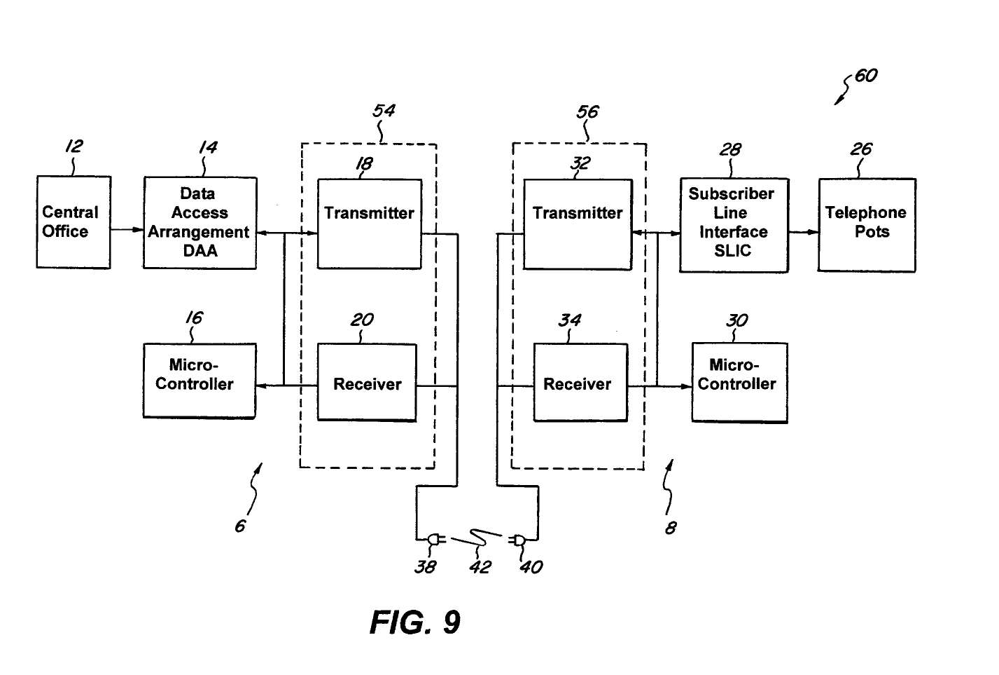

FIG. 9 depicts an alternate embodiment of the base unit 6 and the extension unit 8. In FIG. 9, the antenna 22 and antenna 36 are replaced with power line interface unit 38 and power line interface unit 40 respectively. The base unit 6 and the extension unit 8 can communicate with each other through RF waves and power line channels in the power line 42 using frequency hopping spread spectrum. Furthermore, in FIG. 9, the microcontroller 16 and the microcontroller 30 can control output power to take advantage of the attenuation inherent in electrical wiring in the power line 42 inside of the MDU 2. This power control intelligence can allow dwelling units on either end of the MDU 2 to share the same channel at the same time by achieving a good enough SNR that communication becomes possible.

The transmitter 18 and the transmitter 32 can support modulation of digital data onto the power lines installed in the MDU 2 using one or more of the digital modulation types and allow frequency hopping on multiple channels inside the allocated frequency bandwidth. In one embodiment, the transmitter 18 and the transmitter 32 can support modulation of digital data on at least as many channels as required by a regulatory authority inside the allocated frequency bandwidth.

The receiver 20 and the receiver 34 can support demodulation of digital data from the power lines installed in the MDU 2 in one or more of the digital modulation types and allow frequency hopping on multiple channels inside the allocated frequency bandwidth. In one embodiment, the receiver 20 and the receiver 34 can support modulation of digital data on at least as many channels as required by a regulatory authority inside the allocated frequency bandwidth.

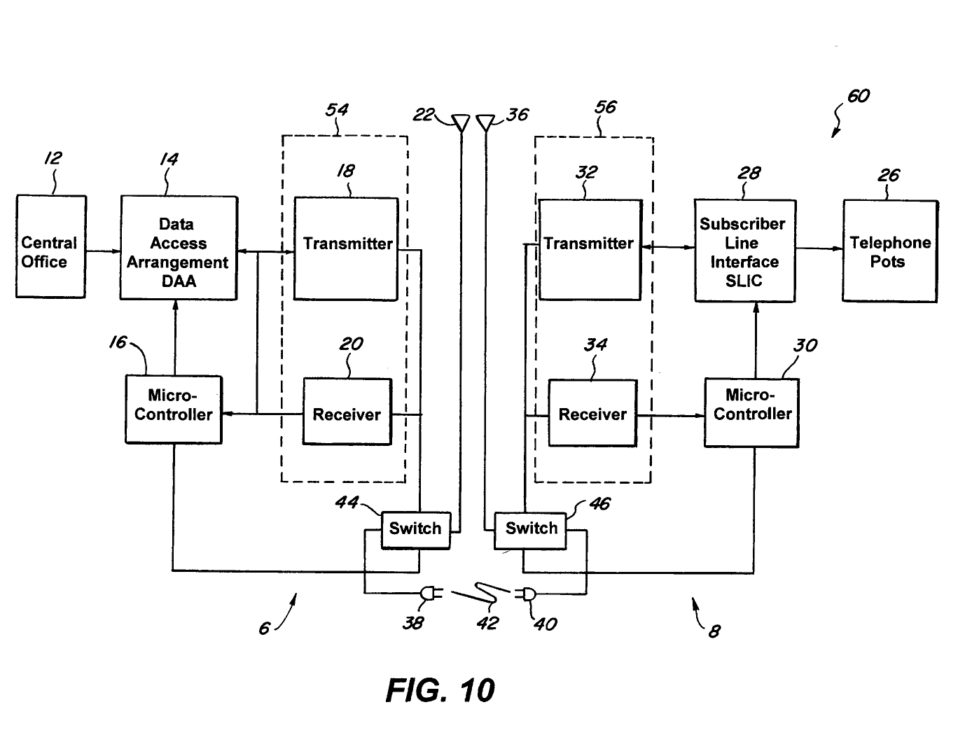

FIG. 10 depicts yet another embodiment of the base unit 6 and the extension unit 8. In FIG. 10, the base unit 6 includes both the antenna 22 and the power line interface unit 38 while extension unit 8 includes both the antenna 36 and the power line interface unit 40. The antenna 22 and power line interface unit 38 are connected by the switch 44 while the antenna 36 and the power line interface unit 40 are connected by the switch 46. The switch 44 can appropriately switch between the antenna 22 and the power line interface unit 38 for base unit 6. Likewise, the switch 46 can appropriately switch between the antenna 22 and power line interface unit 40 for extension unit 8. Thus, the base unit 6 and the extension unit 8 can communicate with each other using RF signals in over-the-air channels and/or power line channels.

In FIG. 10, the microcontroller 16 and/or the microcontroller 30 can perform intelligent arbitration of transferring the desired data using preferred transmission medium, such as over-the-air channels or power line channels, based upon best practices in terms an evaluation of SNR and interference on each medium.

Those of ordinary skill would appreciate that the various illustrative logical blocks, modules, and algorithm steps described in connection with the examples disclosed herein may be implemented as electronic hardware, computer software, or combinations of both. Furthermore, the present invention can also be embodied on a machine readable medium causing a processor or computer to perform or execute certain functions.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The various illustrative logical blocks, units, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in a software module executed by a processor, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. A communication system comprising:
a transceiver transmitting and receiving according to a frequency hopping sequence; and
a microcontroller connected to the transceiver, the microcontroller configured to:
analyze available channels to determine which channels are used by an adjacent communication system; and
set the frequency hopping sequence to avoid using the channels used by the adjacent communication system.

2. The system of claim 1 wherein the microcontroller is further configured to predict which channels are used by the adjacent communication system, and the corresponding times which the channels are used by the adjacent communication system.

3. The system of claim 2 wherein the microcontroller sets the frequency hopping sequence to avoid using the channels used by the adjacent communication system at a same time as the adjacent communication system.

4. The system of claim 1 wherein the microcontroller is further configured to determine a frequency hopping sequence for the adjacent communication system.

5. The system of claim 4 wherein the microcontroller is further configured to
temporally offset the frequency hopping sequence for the adjacent communication system, and
set the frequency hopping sequence to the temporally offset frequency hopping sequence for the adjacent communication system.

6. The system of claim 1 wherein the microcontroller is configured to receive an advertisement of channels used by the adjacent communication system.

7. A method for selecting channel usage by a first communication system with a second communication system adjacent the first communication system, the method comprising:
analyzing available channels to determine which channels are used by the second communication system; and
setting a frequency hopping sequence for the first communication system to avoid using the channels used by the second communication system.

8. The method of claim 7 further comprising predicting which channels are used by the second communication system, and the corresponding times which the channels are used by the second communication system.

9. The method of claim 8 wherein the step of setting a frequency hopping sequence for the first communication system to avoid using the channels used by the second communication system includes setting the frequency hopping sequence to avoid using the channels used by the second communication system at a same time as the second communication system.

10. The method of claim 7 wherein the step of analyzing available channels to determine which channels are used by the second communication system includes determining a frequency hopping sequence for the second communication system.

11. The method of claim 10 wherein the step of setting a frequency hopping sequence for the first communication system to avoid using the channels used by the second communication system includes
temporally offsetting the frequency hopping sequence for the second communication system, and
setting the frequency hopping sequence for the first communication sequence to the temporally offset frequency hopping sequence for the second communication system.

12. The method of claim 7 wherein the step of analyzing available channels to determine which channels are used by the second communication system includes receiving an advertisement of channels used by the second communication systems.

13. The method of claim 7 wherein the step of analyzing available channels to determine which channels are used by the second communication system includes communicating with the second communication systems to determine the channels used by the second communication system.

14. A method for selecting channel usage by a first communication system with a second communication system adjacent the first communication system, the method comprising:
communicating with the second communication system to determine channels used by the first communication system and the second communication system; and
uniquely assigning channels to the first communication system and the second communication system.

15. The method of claim 14 further comprising the step of determining a master base unit and slave base unit between the first communication system and the second communication system.

16. The method of claim 15 wherein the step of uniquely assigning channels to the first communication system and the second communication system includes using the master base unit to uniquely assign channels to the first communication system and the second communication system.

17. The method of claim 15 further comprising selecting a frequency hop for a master synchronization or a slave synchronization.

18. The method of claim 15 further comprising selecting a frequency hop for arbitration communications.

19. The method of claim 18 further comprising formulating arbitration tables.

20. The method of claim 19 further comprising logging unusable channels in an error table.
